(19) United States
(12) Patent Application Publication
(10) Pub. No.: US 2009/0011160 A1
(43) Pub. Date: Jan. 8, 2009

(54) Polymeric Packaging Film

(75) Inventors: Sabine Paulussen, Antwerpen-Deurne (BE); Dirk Vangeneugden, Maasmechelen (BE); Jari Vartiainen, Helsinki (FI); Marjaana Ratto, Vantaa (FI); Eero Hurme, Espoo (FI)

Correspondence Address: MERCHANT & GOULD PC, P.O. BOX 2903, MINNEAPOLIS, MN, 55402-0903, US

(73) Assignees: Vlaamse Instelling Voor Technologisch Onderzoek, Mol (BE); Valtion Teknillinen Tutkimuskeskus, VTT Espoo (FI)

(21) Appl. No.: 11/667,948

(22) PCT Filed: Nov. 14, 2005
(86) PCT No.: PCT/BE05/00164

§ 371 Date: Aug. 13, 2008

(30) Foreign Application Priority Data
Nov. 16, 2004 (GB) 0425288.8

(51) Int. Cl. B32B 27/32; H05H 1/00; B32B 27/06; A22C 13/00

(52) U.S. Cl. 428/34.8; 427/536; 428/523; 428/532

(57) ABSTRACT

A polymeric film has at least one surface on which chitosan has been immobilised so as to be substantially resistant to leaching and have a strong antimicrobial activity. The polymeric film may be a polyolefin film such as a biaxially orientated polypropylene film. A process immobilises chitosan on a polymeric surface so as to be resistant to leaching and have a strong antimicrobial activity by applying chitosan to a polymeric film surface which has been activated before addition of chitosan to the surface by plasma activation at atmospheric pressure.

### FIELD OF THE INVENTION

The present invention is related to antimicrobial packaging materials, more particularly to polymeric films for use in active food packaging systems.

### STATE OF THE ART

Active food packaging systems can effectively control the microbial contamination of various solid and semisolid foodstuffs by inhibiting the growth of micro-organisms on the surface of the food, which normally comes into direct contact with the packaging material.

Chitosan, the β-1-4-linked polymer of 2-amino-2-deoxy-β-D-glucan, is prepared by N-deacetylation of chitin, the second most abundant natural biopolymer after cellulose. Chitosan is an edible biodegradable material, which has antimicrobial activity against different groups of micro-organisms, both bacteria, yeasts and moulds. Chitosan has been used in forming laminates for use in food packaging. Films and membranes have been formed from solutions of chitosan in acid solutions.

Document EP0369787 describes the preparation of a membrane, for the separation of a water-alcohol mixed liquid by the pervaporation method, the membrane being composed of a chitosan having a molecular weight of 80,000 to 150,000 and a deacetylation degree adjusted to 80 to 95% prepared by dissolving a chitosan in an acidic aqueous solution to form a dope having the chitosan concentration of 9 to 12% by weight, shaping the dope into a membrane and immersing the membrane in an alkaline solution.

Document U.S. Pat. No. 6,746,762 claims a film selectively permeable to carbon dioxide gas for food packaging comprising a laminate film comprising at least three layers composed of an outer layer, an intermediate layer and an inner layer, wherein the outer layer and the inner layer comprise a thermoplastic resin and the intermediate layer comprises a chitosan having a degree of deacetylation of 70 mol %. Thus when used in a packaging laminate for foodstuffs, the chitosan film is protected from any contact with the foodstuff. Furthermore in the coating method disclosed in U.S. Pat. No. 6,746,762, the chitosan film obtained after drying is treated with an alkaline aqueous solution, for example dipping it in an aqueous sodium hydroxide solution (for example, dipping it in an aqueous 1 N sodium hydroxide solution for 0.5 seconds to 48 hours), and then washing it with water (for example, in tap water for 1 second to 1 hour) to obtain a film made of chitosan which is insoluble in water. This washed film must then be subjected to a further drying step.

### SUMMARY OF THE INVENTION

The present invention is related to a process and product as described in the appended claims. The process comprising the steps of subjecting a polymeric film to a plasma activation prior to the coating of the film with a solution comprising chitosan, so as to obtain immobilised chitosan on the film. The invention is equally related to a polymeric film on which chitosan has been immobilised.

### SHORT DESCRIPTION OF THE DRAWINGS

FIG. 1 illustrates the results of tests of the anti-microbial activity of a biaxially orientated polypropylene (BOPP) film.

### DETAILED DESCRIPTION OF THE INVENTION

According to the invention there is provided a polymeric film having at least one surface on which chitosan has been immobilised so as to be substantially resistant to leaching and have a strong antimicrobial activity. The polymeric film may be a polyolefin film such as a biaxially orientated polypropylene film.

It has been found surprisingly that chitosan may be immobilised on a polymeric surface so as to be resistant to leaching and have a strong antimicrobial activity by applying chitosan to a polymeric film surface which has been activated before addition of chitosan to the surface by plasma activation at atmospheric pressure.

The addition of chitosan to the activated surface may be carried out by coating the activated surface with an acidic solution of chitosan containing a cross linking agent for chitosan, and then drying the coated film. According to a preferred embodiment, solutions of chitosan in dilute acetic acid are used. Aldehydes are known crosslinking agents for chitosan and such aldehydes include monoaldehydes, such as formalin, acetoaldehyde, propionaldehyde and butyric aldehyde, polyaldehydes, such as glyoxal, glutaraldehyde and dialdehyde starch. The preferred cross linking agent of the invention is glutaraldehyde.

The invention is equally related to a process for producing a polymeric film on which chitosan has been immobilised, wherein the film is plasma-activated prior to applying chitosan, said plasma-activation taking place in a plasma at atmospheric pressure.

According to the preferred embodiment, the invention is related to a process for forming immobilised chitosan on a hydrophobic polymeric surface in which the chitosan is applied to a surface which has been plasma-activated in a dielectric barrier discharge reactor provided with two parallel electrodes at atmospheric pressure in the presence of nitrogen and ammonia. In a preferred form of the process, nitrogen flows through the reactor during activation at about 20 l/min and ammonia is added at about 3 l/min. According to an alternative embodiment, CO₂ is used in stead of nitrogen and ammonia. In that case, the preferred cross-linking agent is cyanamide.

It has been found that when the electrodes in the reactor are separated by a distance of 2 mm, and an AC field is applied to them so as to produce a plasma discharge with a power of 0.5 W/m², an activated surface is produced which when treated with an acidic solution of chitosan containing a cross-linking agent converts the surface into one carrying immobilised chitosan in a form both resistant to leaching and having anti-microbial properties.

It has been found that a surface on which chitosan has been immobilised by the process of the present invention has excellent oxygen barrier properties enhancing the use of polymeric films with such a surface for food packaging.

The invention is equally related to a food package having anti-microbial properties associated with a low oxygen transmission, said package being formed from a biaxially oriented polypropylene film on at least one surface of which chitosan has been immobilised so as to be substantially resistant to leaching.

The invention also includes a polymeric film and packages made therefrom which meet the requirements stipulated with regards to leaching in Directive 2002/72 EC relating to plastic materials designed to come into contact with foodstuffs.

### DESCRIPTION OF A PREFERRED EMBODIMENT OF THE INVENTION

The following example illustrates but does not limit the invention. The materials used in forming an immobilised chitosan coating on biaxially oriented polypropylene were sourced as follows:

Chitosan, medium molecular weight, was obtained from Aldrich Chemical Company, Inc., Milwaukee, Wis., USA. Glutaraldehyde, 25% solution was obtained from Merck-Schuchardt, Hohenbrunn, Germany and N-(3-Dimethylaminopropyl)-N′-ethylcarbodiimide hydrochloride (EDC) from Fluka. Acid Orange 7 was obtained from Sigma-Aldrich and Toluidine Blue O from Merck. Biaxially oriented polypropylene (BOPP) films (thickness 25 μm) were from UCB Films, United Kingdom.

Plasma Activation

Plasma activation was carried out in a dielectric barrier discharge (DBD)-reactor at atmospheric pressure. The configuration consists of two parallel electrodes (20×25 cm) covered with a dielectric material, in this case glass. The inter-electrode distance was set at 2 mm and samples of BOPP film were placed on the lower electrode. Standard purity nitrogen was used as inert carrier gas. The flow rate was controlled by mass flow controllers and set at 20 l/min. During activation, NH₃ was added to the nitrogen flow at a rate of 3 l/min. An AC-field with a frequency of 2 kHz, generated by a 20 kV/200 mA AC power supply was applied to the electrodes, giving rise to a transient, spatially uniform glow with a power density of 0.5 W/m². The activation was carried out for 0.5 min.

Chitosan Addition

Chitosan (1% w/v) was dissolved in 0.1 M acetic acid by stirring on a magnetic stirrer for two days. 0.1% glutaraldehyde was added after which the solution was immediately applied onto BOPP film samples. Drying of the films was performed at 80 C. for two hours.

Fourier Transform Infrared Spectroscopy (FTIR)

FTIR (Bruker Equinox 55 spectrometer with photo acoustic detector) was used to determine the chemical changes between the original and surface treated films as well as confirm the successful immobilization of chitosan onto BOPP surface.

Water Uptake

Film samples were completely dried in desiccator at room temperature. After the dry weights were registered, the samples were placed in 75% relative humidity attained using saturated sodium chloride solution. After the samples had reached the equilibrium state, the weights were measured again and the following equation was used to calculate the water uptake (W):

$$W = \frac{{W}_{h} - {W}_{d}}{{W}_{d}} \qquad ( 1$$

where Wₕ represents the weight of the sample after high humidity (75% RH) conditioning and W_{d} is the weight of the dry sample.

Oxygen Transmission Determination

Measurements for the samples were performed with Ox-Tran 2/20 Oxygen Transmission Rate System (Mocon, Modern Controls, Inc., USA) using the method described in the standard ASTM D3985-81. Tests were carried out at 23° C. temperature and 0% relative humidity using 100% oxygen as test gas. Aluminium foil masks, with an inner diameter area of 5 cm², were used to mount test pieces in the diffusion cell.

Light Absorption

UV-visible light absorption of the film samples between 200-800 nm was determined using Cary 100 Bio UV Visible Spectrophotometer. Transparency was determined by measuring the % transmittance of light at 600 nm.

Color Measurement

Hunter L, a and b values were measured using a calorimeter (CR-210 Minolta Chroma Meter, Minolta Camera Co., Osaka, Japan). L value indicates lightness: L=0 (black) and L=100 (white) whereas a and b indicate color directions: +a (red), −a (green), +b (yellow) and −b (blue). Color values were determined randomly at five different positions using three individually prepared films, thus the values were averaged from totally fifteen replicated readings. Films were measured on the surface of A4 sized white copy paper with color values of L=91.83, a=0.90 and b=−2.54. Total color difference (ΔE) was calculated from equation:

ΔE=\sqrt{(L_{film}−Lₚₐₚₑᵣ)²+(a_{film}−aₚₐₚₑᵣ)²+(b_{film}−bₚₐₚₑᵣ)²} (2)

Migration Test

Migration tests were carried out as described in European prestandard ENV 1186-3 ‘Materials and articles in contact with foodstuffs—Plastics—Part 3: Test methods for overall migration into aqueous food simulants by total immersion’. 3% acetic acid and 95% ethanol were used as food simulants in test conditions of 10 days at 40° C. Iso-octane, which can be used as an alternative fatty food simulant, was used in conditions of 2 hours at 20° C. Tests were performed by immersing test specimens in food simulant, after which the simulant was evaporated to dryness and the overall mass of the residue was determined.

Antimicrobial Activity

The antimicrobial activity of the coated films against Escherichia coli (ATCC 11775) and Bacillus subtilis (Merck 1.10649) was measured using the antimicrobial drop test.²⁴ E. coli culture cultivated in TSB (EBL) for 24 h 37° C. and Bacillus subtilis spore suspension were diluted into sterile peptone-saline to contain approximately 1×10⁶ cfu/ml. The samples were cut into 1.5×1.5 test pieces and each piece was placed into a Petri dish. 0.1 ml of bacterial suspension was placed on each test piece. The Petri dishes were placed on a tray containing a wetted paper sheet, covered with a lid and incubated for 24 h at 30° C. After incubation 5 ml of peptone-saline was added in the Petri dishes and the bacteria were washed from the test pieces by shaking (Infoss AG CH 4103 orbital shaker, 100 rpm) for 5 min at 25° C. The number of surviving bacteria was measured by plating on TSB plates and incubating for 24 h at 37° C. (Escherichia coli) or 30° C. (Bacillus subtilis).

The results of the above determinations are given in the tables below where:

Table 1 sets out the result of determining the amount of immobilized chitosan on BOPP films. The amounts on the surface with and without plasma activation at atmospheric pressure were determined and with and without the cross linking agent on a surface activated with plasma at atmospheric pressure.

TABLE 1
Amount of immobilized chitosan on BOPP films.

| | Chitosan | |
|---|---|---|
| | g/m² | |
| | BOPP | BOPP |
| | (without | (N₂-plasma + |
| Coating solution | plasma) | NH₃) |
| 1% chitosan in 0.1 M acetic acid | 0.13 | 0.20 |
| 1% chitosan in 0.1 M acetic acid + 0.1% | 0.70 | 1.75 |
| glutaraldehyde | | |

Table 2 shows that the water uptake of BOPP films slightly increased because of immobilized chitosan. BOPP, as other synthetic polymers, is hydrophobic, whereas the cationic polysaccharide structure of chitosan is very hydrophilic. In this case, the addition of glutaraldehyde probably formed a cross-linked chitosan coating, which was only swollen but not dissolved by the water absorption.

TABLE 2
Water uptake of BOPP films.

| | Water |
|---|---|
| Film | uptake % |
| BOPP (without plasma) | 0 |
| BOPP (N₂-plasma + NH₃) | 0 |
| BOPP (N₂-plasma + NH₃) + 1% chitosan in 0.1 M | 0.01 |
| acetic acid + 0.1% glutaraldehyde | |

Table 3 shows how oxygen transmission rates fell from 1500 to 27 cm³/(m²·24 h) because of chitosan forming a oxygen barrier.

TABLE 3
Oxygen transmission (OTR) of BOPP films.

| | OTR |
|---|---|
| Film | cm³/(m² · 24 h) |
| BOPP (without plasma) | 1500 |
| BOPP (N₂-plasma + NH₃) | 1500 |
| BOPP (N₂-plasma + NH₃) + 1% chitosan in 0.1 M acetic | 27 |
| acid + 0.1% glutaraldehyde | |

Table 4 shows that BOPP with immobilised chitosan which has been applied to the surface in the presence of an aldehyde applied becomes coloured. This is due to the reaction between amino groups on chitosan and glutaraldehyde forming a Shiff base and which is coloured and gives the film a slightly yellowish indicating absorption of light at wave lengths above 400 nm. The colour formation is probably due to a three-dimensional network structure of cross-linked chitosan.

TABLE 4
ΔE and transparency of BOPP films.

| Film | ΔE | Transparency % |
|---|---|---|
| BOPP (without plasma) | 1.2 | 100 |
| BOPP (N₂-plasma + NH₃) | 0.9 | 90.6 |
| BOPP (N₂-plasma + NH₃) + 1% chitosan | 4.6 | 92.1 |
| in 0.1 M acetic acid + 0.1% glutaraldehyde | | |

Table 5 lists the results obtained in measuring total migration which confirmed that the cross-linked chitosan was permanently immobilized onto BOPP without any significant leaching. The amounts of dissolved substances in 3% acetic acid, 95% ethanol and iso-octane were below 2 mg/dm². This means that the material met the requirements set for the total migration of substances migrated from the packaging materials into foodstuffs stipulated in Directive 2002/72/EC.

TABLE 5
Overall migration of BOPP films in three different
simulants expressed as mg/dm².

| | Overall migration | | |
|---|---|---|---|
| | mg/dm² | | |
| | | 3% acetic | 95% |
| | | acid | ethanol |
| | iso-octane | 10 days at | 10 days at |
| Coating solution | 2 h at 20° C. | 40° C. | 40° C. |
| BOPP (without plasma) | <1 | 1 | <1 |
| BOPP (N₂-plasma + NH₃) | <1 | <1 | <1 |
| BOPP (N₂-plasma + NH₃) + 0.1% | 1 | <1 | 1 |
| glutaraldehyde + chitosan^{a} | | | |

^{a}Chitosan (1%) in 0.1 M acetic acid

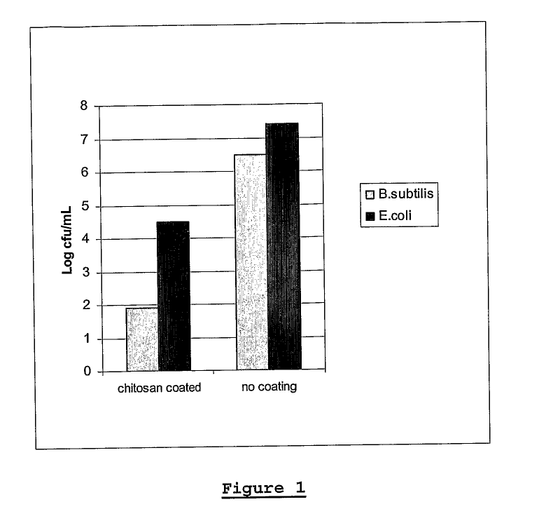

FIG. 1 illustrates the results of tests of the anti-microbial activity of the BOPP film with immobilised chitosan on its surface with material free of chitosan and shows the high activity of the material on which chitosan had been immobilised. The survival of E. coli and B. subtilis (24 h in peptone saline at 30° C.) on plasma activated BOPP films with surface immobilized chitosan (0.1% glutaraldehyde as linking agent) is compared to BOPP films free of chitosan.

1. A process for forming immobilised chitosan on at least one surface of a polymeric film, comprising the steps of:
providing said polymeric film,
activating said surface by a plasma at atmospheric pressure,
applying chitosan to the activated surface.

2. The process according to claim 1, wherein:
the surface of said polymeric film is hydrophobic,
said plasma-activation takes place in a dielectric barrier discharge reactor, provided with two parallel electrodes, in the presence of nitrogen and ammonia, and
the step of applying chitosan takes place by coating the activated surface with an acidic solution of chitosan containing a cross linking agent for chitosan, followed by the step of drying the coated film.

3. The process according to claim 2, wherein during activation, nitrogen flows through the reactor at about 20 l/min, and ammonia is added at about 3 l/min.

4. The process according to claim 2, wherein the electrodes in the reactor are separated by a distance of 2 mm and an AC field is applied to them so as to produce a plasma discharge with a power of 0.5 W/m².

5. The process according to claim 2, wherein said acidic solution is formed by dissolving chitosan in dilute acetic acid.

6. The process according to claim 2, wherein said cross-linking agent is glutaraldehyde.

7. The process according to claim 1, wherein said polymer film is a polyolefin film.

8. The process according to claim 7, wherein said polymeric film is a biaxially orientated polypropylene film.

9. The process according to claim 2, wherein said plasma-activation takes place in the presence of CO₂, in stead of nitrogen and ammonia.

10. The process according to claim 9, wherein said cross-linking agent is cyanamide.

11. A polymeric film having at least one surface on which chitosan has been immobilised so as to be substantially resistant to leaching and have a strong antimicrobial activity.

12. A polymeric film as claimed in claim 11 wherein the polymeric film is a polyolefin film.

13. A polymeric film as claimed in claim 12 wherein the polyolefin film is a biaxially orientated polypropylene film.

14. A food package having anti-microbial properties associated with a low oxygen transmission, said package being formed from a biaxially oriented polypropylene film, on at least the food contact surface of which chitosan has been immobilised so as to be substantially resistant to leaching.

15. The process according to claim 3, wherein the electrodes in the reactor are separated by a distance of 2 mm and an AC field is applied to them so as to produce a plasma discharge with a power of 0.5 W/m².
